(19) United States
(12) Patent Application Publication
(10) Pub. No.: US 2012/0217743 A1
(43) Pub. Date: Aug. 30, 2012

(54) PIPE COUPLING ASSEMBLY WITH SLEEVE LOCKING TABS AND ASSOCIATED METHODS

(76) Inventor: JOSEPH SALVATORE PARISI, DELRAY BEACH, FL (US)

(21) Appl. No.: 13/403,179

(22) Filed: Feb. 23, 2012

Related U.S. Application Data
(60) Provisional application No. 61/446,469, filed on Feb. 24, 2011.

(51) Int. Cl. F16L 21/02; B23P 17/00

(52) U.S. Cl. 285/373; 29/890.14

(57) ABSTRACT

A pipe coupling assembly includes a pair of casing members each having a first end including a first continuous exterior surface edge defined by a first radius, and a second end including a second continuous exterior surface edge defined by a second radius. The first radius is smaller than the second radius so that a tapering, continuous, exterior surface extends therebetween. A gasket is to be positioned adjacent first and second pipe sections, and within the pair of casing members. A sleeve has a tapering interior surface to be positioned over the tapering, continuous, exterior surfaces of the pair of casing members. The second end of at least one of the pair of casing members includes a sleeve locking tab extending outwards from the second continuous, exterior surface edge so that the sleeve is lockable in position surrounding the pair of casing members by engagement with the sleeve locking tab.

### RELATED APPLICATIONS

This application claims the benefit of U.S. Provisional Application Ser. No. 61/446,469 filed Feb. 24, 2011, the entire contents of which are incorporated herein by reference.

### FIELD OF THE INVENTION

The present invention relates to a pipe coupling assembly for connecting a pair of pipe sections, and more particularly, to a pipe coupling assembly and associated methods utilizing a sleeve that slides over a pair of casing members and is locked in position.

### BACKGROUND OF THE INVENTION

Piping systems are known for conveying fluids, including liquids and gasses. The systems may include domestic plumbing systems installed in a building for conveying fluids such as water, oil, natural gas, propane, sewage, and the like. These plumbing systems may include pipes for building heating systems, fire protection sprinkler systems, rising mains pipes and waste water pipes. The systems may also include oil and gas pipelines for conveying fuel over thousands of miles and pipe systems used in mining applications. The pipe sections, also referred to as tubular conduits, may be made in any of a variety of metals, including steel, iron, copper, aluminum and plastic.

For smaller diameter pipes less than 2 inches (5 cm), push fit couplings can be used, for example, as described in Great Britain Patent No. 2,378,992. However, for pipe diameters above 2 inches, the force required to push the end of a pipe into such a push fit coupling becomes too high for a manual connection. In addition, pipes connected by push fit couplings are able to rotate relative to each other, which can cause valve taps to move out of an optimum position.

For larger diameter pipes, welded joints are typically used. However, welded joints have the disadvantage of requiring skilled workers as well as having negative health and safety and environmental implications. For example, the construction of a gas conveying pipeline made from 130 foot (40 meter) long lengths of steel pipe, and with a 3 foot (1 meter) diameter, conventionally use welded joints. Each joint can take a skilled team a whole day to make, when taking into consideration the deployment of equipment at the joint location and inspection of the joint by X-ray equipment. Also, around 1 in 10 of such welded joints will have to be repaired after such an inspection. This makes pipelines expensive and time consuming to construct.

Where plastic pipes are used, heat fused joints may be used, wherein the ends of the pipes to be connected are heated and then fused together. Push fit couplings, welded joints and fused joints are difficult to disconnect for repair or maintenance, for example, with such disconnection often causing damage to the pipes.

One approach for a pipe coupling assembly is known as a Victaulic (also known as victolic) pipe joint 100, an example of which is illustrated in FIGS. 1 and 2. The pipe ends to be connected are formed with an annular groove in their external surface. A pair of pipe sections 140, 142 is arranged in a linear configuration. An annular resilient gasket 150, having a C-shaped longitudinal cross-section, is positioned over each of the ends of the pipe sections 140, 142 being joined, whereby the gasket 150 straddles the two pipe sections 140, 142. Typically, the gasket 150 is stretched slightly to fit over the ends of the pipe sections 140, 142 so that the gasket 150 forms a seal between the first pipe section 140 and second pipe section 142. The gasket 150 is encased by placing a first rigid Victaulic-type casing member 110 and a second rigid Victaulic-type casing member 112 over the circumference of each of the pipe sections 140, 142.

A coupling groove 136 is provided circumferentially about a contacting (interior) surface of the first rigid Victaulic-type casing member 110. The coupling groove 136 engages with a coupling ridge 146 formed in each of the mating ends of the pipe sections 140, 142. Generally, the Victaulic style coupling assembly 100 is formed having a first rigid Victaulic-type casing member 110 and a second rigid Victaulic-type casing member 112. A pair of first casing member flanges 120 extends outward from each mating end of the first rigid Victaulic-type casing member 110.

Similarly, second casing member flanges 122 extend outward from each mating end of the second rigid Victaulic-type casing member 112. Each of the first casing member flanges 120 and second casing member flanges 122 are joined together by a mechanical fastener 130 inserted therethrough. The mechanical fastener 130 is preferably a threaded mechanical fastener. The first and second rigid Victaulic-type casing members 110, 112, when assembled, compress the gasket 150 to further improve and retain the seal between the pipe sections 140, 142.

However, there are known problems with such Victaulic-type pipe joints 100. The first is that they may not be well suited to high pressure pipe systems. In particular, where one of the pipe elements being coupled together comprises a pipe end cap, the joint has to withstand significant forces acting to pull apart the pipe ends connected by the joint. When fluid pressure builds up within the Victaulic pipe joint 100, the pressure acts radially outwardly on the gasket 150, causing the gasket 150 to inflate and apply a radially outwardly directed force to the first and second rigid Victaulic-type casing members 110, 112. That is, the pressure acts in the direction of the double headed arrow, labeled “pressure.”

This force acts to separate the first and second rigid Victaulic-type casing members 110, 112, and so high fluid pressure within the pipe joint is transferred to the mechanical fastener 130 and flanges 120, 122 holding the first and second rigid Victaulic-type casing members 110, 112 together. Such Victaulic-type pipe joints 100 are typically rated to fluid pressures of 150 psi and have been known to fail around 200 psi, typically by failure of the mechanical fasteners 130.

In addition, pipes connected by a Victaulic-type pipe joint 100, of the type shown in FIGS. 1 and 2, may be able to rotate with respect to each other and with respect to the first and second rigid Victaulic-type casing members 110, 112, which may cause problems of movement of pipe valves (not shown), etc., to inaccessible locations. Victaulic-type pipe joints 100 can also fail if any of the mechanical fasteners 130 become loose due to vibration of the pipe system.

Another example of a Victaulic-type pipe joint 160 is illustrated in FIGS. 3 and 4. The pipe coupling assembly 160 includes a pair of casing members 170, 172 each having a first end comprising a first exterior surface edge 174 defined by a first radius, and a second end comprising a second exterior surface edge 176 defined by a second radius, with the first radius being smaller than the second radius so that a tapering, exterior surface 178 extends therebetween. A gasket 180 is positioned adjacent the first and second pipe sections 140, 142, and within the pair of casing members 170, 172.

A sleeve 182 has a tapering interior surface 184 to be positioned over the tapering, exterior surfaces 178 of the pair of casing members 170, 172. To lock the tapered sleeve 182 in place, a set screw 190 is positioned through a threaded opening 192 that extends through the sleeve and is tightened against one of the casing members 170, 172. A disadvantage of using a set screw 190 is that it may be difficult to work with at times, such as when wearing gloves, since it is small in size. Inserting and tightening the set screw 190 adds to the time it takes to properly couple a pair of pipe sections together. Also, additional machining is required to form the threaded opening 192 in the sleeve 182, and to machine one of the casing members 170, 172 with an indention 194 to receive the set screw 190. Once installed, the set screw 190 may back itself out due to vibration of the pipe system, leading to failure of the pipe joint 160.

Yet another example of a wedge style coupling assembly 200 that includes a sleeve engaging member 226 is illustrated in FIGS. 5 through 8. The wedge style coupling assembly 200 comprises a first casing member 210 and a second casing member 212 that are secured onto a pair of pipe sections 240, 242 by a pressure application sleeve 260. The first casing member 210 and second casing member 212 are formed comprising like features.

Each of the first casing member 210 and second casing member 212 is preferably fabricated in a half-annular configuration having a “C” shaped longitudinal cross section shape. The first casing member 210 is illustrated, where the second casing member 212 mirrors the features of the first casing member 210. The first casing member 210 is defined by a larger radiused end 222 having an exterior radius defined as R1, a smaller radiused end 224 having an exterior radius defined as R2, and a pressure receiving surface 220 having a sectioned conically shape surface spanning therebetween. The radius R1 is greater than the radius R2, which defines the degree of taper of the pressure receiving surface 220.

A coupling ridge 236 extends radially inward proximate each end of the first casing member 210. An optional longitudinally extending gripping teeth area 232 can be provided upon a pipe contacting surface of the first casing member 210 to ensure against rotation or other undesired motion of the pipe sections 240, 242. A gasket receiving feature 230 extends inward as a recess within the contacting side of the first casing member 210. The gasket receiving feature 230 is preferably centrally located and would be sized, shaped, and positioned to receive and support a gasket 250 when subjected to fluid pressure.

A sleeve engaging member 226 is provided upon an outer edge of the smaller radiused end 224. The sleeve engaging member 226 is a cantilevered stop,

The pressure application sleeve 260 is defined by a larger diameter end 272 having an inner diameter referenced as D1, a smaller diameter end 274 having an inner diameter referenced as D2, and a pressure application sleeve interior surface 270 having a sectioned conically shape surface spanning therebetween. The pressure application sleeve interior surface 270 is sized and shaped to mate with the pressure receiving surface 220, thus securing the first casing member 210 and the second casing member 212 into position and applying sufficient pressure to adequately seal the connection between the first and second pipe sections 240, 242. The inner diameter D1 is sized respective to two exterior radii R1, and the inner diameter D2 is sized respective to two exterior radii R2.

The exterior shape and diameter of the pressure application sleeve 260 is based upon the material selection, the anticipated forces applied thereunto, and designers choice. The exterior shape can be a parallel surface, a tapered surface, and the like. A mating sleeve engaging feature 276 is integrated into an interior edge of the smaller diameter end 274, where the mating sleeve engaging feature is located, sized and shaped to receive the sleeve engaging member 226.

The pressure application sleeve 260 is slipped onto the pipe sections 240, 242 respective to the smaller diameter end of the casing members 210, 212. The pipe fitting installer needs to consider proper location and orientation when staging the pressure application sleeve 260 onto the pipe sections 240, 242 to avoid having to subsequently disassemble the arrangement. The mating pipe sections 240, 242 are placed into the desired configuration. The gasket 250 is positioned spanning between each of the ends of the pair of pipe sections 240, 242 to create a fluid seal therebetween.

The first casing member 210 and the second casing member 212 are positioned onto an outer surface of each of the two pipe sections 240, 242 abutting each of the planar edges of the casing members 210, 212. The gasket 250 is seated within the gasket receiving feature 230. The casing members 210, 212 are oriented with like edge in registration to one another to form a tapered or conically shaped pressure receiving surface 220. The coupling ridge 236 is sized, shaped, and positioned to insert into a coupling groove 246 formed proximate a connecting end of each of the pipe sections 240, 242.

The engagement between the coupling ridge 236 and the coupling groove 246 retain the pipe sections 240, 242 along a longitudinal axial direction. The pressure application sleeve 260 is assembled onto the casing members 210, 212 by placing the pressure application sleeve 260 over positioned casing members 210, 212 and sliding the pressure application sleeve 260 onto the casing members 210, 212 from the smaller radiused end 224 towards the larger radiused end 222, as illustrated in FIG. 8. The application may require assistance of a hammer, a clamp, or other force-applying instrument to properly seat the pressure application sleeve 260 onto the casing members 210,212.

The sleeve engaging member 226 elastically deforms downward and returns to a natural, securing state, seating within a mating sleeve engaging feature 276. The sleeve engaging member 226 engages with the mating sleeve engaging feature 276 to retain the pressure application sleeve 260 in position. As the pressure application sleeve 260 is pressed onto the casing members 210, 212, the tapered surfaces increase the compression force of the wedge style coupling assembly 200 as applied to the pipe junction.

Unfortunately, there is a disadvantage with the open spaces 225 notched out of the casing members 210, 212 adjacent he sleeve engaging members 226 formed therein to provide the cantilever action. Although the figures are not drawn to scale, as pressure builds up within the coupling assembly 200, the gasket 250 may expand within the first and second casing members 210, 212 to the point where it bulges out through the opening spaces 225 and the joint fails.

Therefore, a reliable coupling system for mating a pair of pipe sections requiring a short assembly cycle time is desired. It is also desirous to utilize a coupling that is removable to allow for separation of the two pipe sections for maintenance.

### SUMMARY OF THE INVENTION

In view of the foregoing background, an object of the present invention is to provide a straightforward pipe coupling assembly that reliably secures a pair of pipe sections together.

This and other objects, advantages and features in accordance with the present invention are provided by a pipe coupling assembly that includes a pair of casing members each having a first end including a first continuous exterior surface edge defined by a first radius, and a second end including a second continuous exterior surface edge defined by a second radius. The first radius is smaller than the second radius so that a tapering, continuous, exterior surface extends therebetween. A gasket is to be positioned adjacent first and second pipe sections, and within the pair of casing members. A sleeve has a tapering interior surface to be positioned over the tapering, continuous, exterior surfaces of the pair of casing members. The second end of at least one of the pair of casing members includes a sleeve locking tab extending longitudinally and radially outwards from the second continuous, exterior surface edge so that the sleeve is lockable in position surrounding the pair of casing members by engagement with the sleeve locking tab.

For a typical pipe coupling, a locking tab is provided on each casing member since the sleeve locking tab extends longitudinally and radially outwards from the second exterior surface edges, this allows the exterior surface edges of the second ends of the first and second casing members to be continuous. This allows the gasket to remain properly seated within the first and second casing members when under pressure. In addition, vibration of the pipe coupling assembly will not cause the sleeve to slip off the first and second casing members.

The first sleeve locking tab may be integrally formed with the first casing member, and the second sleeve locking tab may be integrally formed with the second casing member. The first and second sleeve locking tabs and the first and second casing members may comprise plastic.

The first and second sleeve locking tabs may each extend radially outward and inward from a respective second continuous, exterior surface edge a distance less than a corresponding radial thickness of adjacent portions of the sleeve. Alternatively, the first and second sleeve locking tabs may each extend radially outward and inward from a respective second continuous, exterior surface edge a same distance. The first and second sleeve locking tabs may each extend radially outward from a respective second continuous, exterior surface edge to define a respective sleeve contacting surface being flush with an end face of a respective casing member.

The first and second sleeve locking tabs may each comprise rounded over surface portions adjacent respective sleeve contacting surfaces. The first and second sleeve locking tabs may each be positioned at a respective midpoint of a respective casing member.

Another aspect is directed to a method for making a pipe coupling assembly as described above.

### BRIEF DESCRIPTION OF THE DRAWINGS

The invention will now he described, by way of example, with reference to the accompanying drawings, where like numerals denote like elements and in which:

FIG. 1 presents an end view of an exemplary Victaulic-type pipe coupling arrangement in accordance with the prior art;

FIG. 2 presents a side section view of the exemplary Victaulic-type pipe coupling of FIG. 1;

FIG. 3 presents an exploded view of another embodiment of a Victaulic-type pipe coupling arrangement in accordance with the prior art;

FIG. 4 presents an assembled view with a sectional cutout of the exemplary Victaulic-type pipe coupling of FIG. 3;

FIG. 5 presents a sectioned side view of a pipe coupling assembly with cantilevered sleeve engaging members in accordance with the prior art, the section view taken along a longitudinal axis of the pipe coupling assembly and centered along a pipe engaging section;

FIG. 6 presents a sectioned side view of the pipe engaging section of FIG. 5 without the pressure application sleeve, the section view is shown bisecting the pipe engaging section parallel to a longitudinal axis;

FIG. 7 presents a sectioned side view of the pressure application sleeve of FIG. 5, the section view is shown bisecting the sleeve parallel to a longitudinal axis;

FIG. 8 presents a sectioned side view of the pipe coupling assembly as illustrated in FIG. 5, shown in a partially assembled state;

FIG. 9 presents an isometric exploded assembly view of a pipe coupling assembly with sleeve locking tabs in accordance with the present invention;

FIG. 10 presents a side elevation view of the pipe coupling assembly of FIG. 9;

FIG. 11 presents a side sectioned view of the pipe coupling assembly of FIG. 9 taken along a centered longitudinal axis;

FIG. 12 presents a partial side sectioned view of the pipe coupling assembly of FIG. 9 with the sleeve locking tab engaging the sleeve;

FIG. 13 presents a partial front view of the pipe coupling assembly of FIG. 9 with the sleeve locking tab engaging the sleeve;

FIG. 14 is a flowchart illustrating a method for making a pipe coupling assembly in accordance with the present invention.

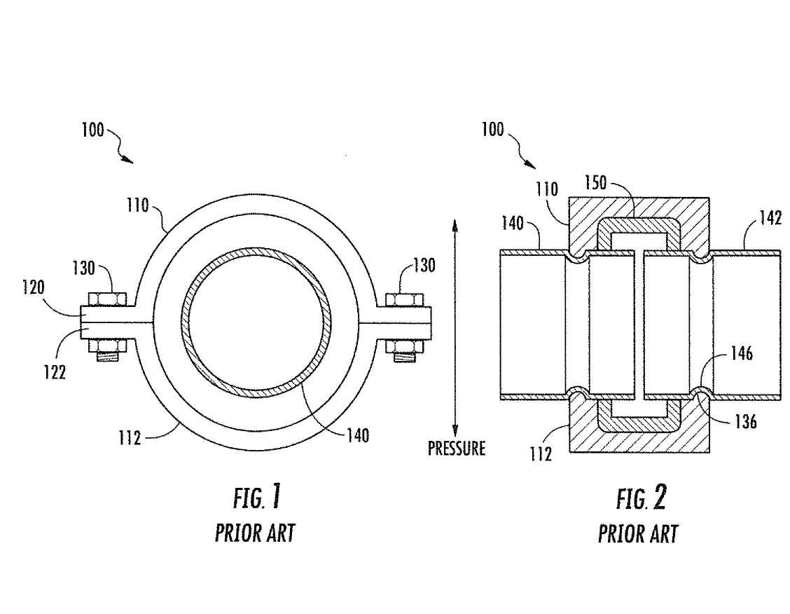

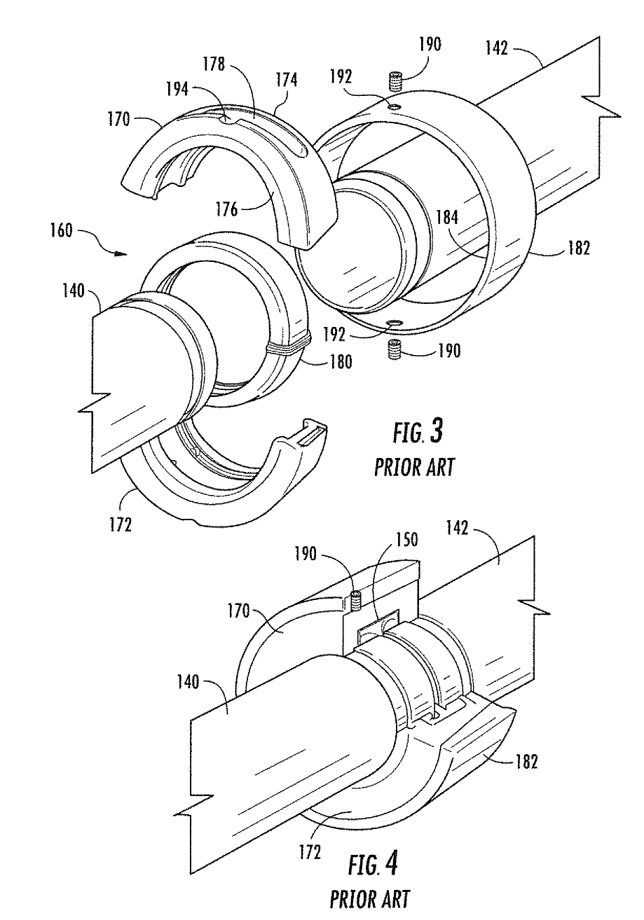

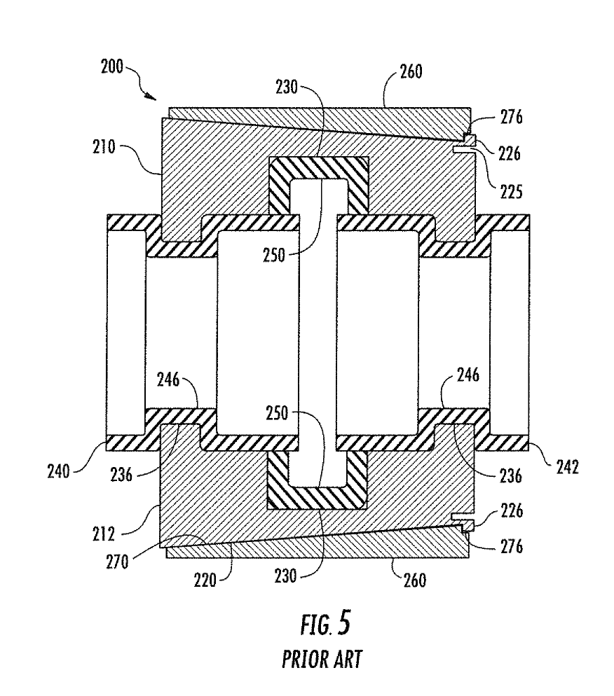

### DETAILED DESCRIPTION OF THE PREFERRED EMBODIMENTS

The following detailed description is merely exemplary in nature and is not intended to limit the described embodiments or the application and uses of the described embodiments. As used herein, the word “exemplary or illustrative” means “serving as an example, instance, or illustration.” Any implementation described herein as “exemplary or illustrative” is not necessarily to be construed as preferred or advantageous over other implementations.

All of the implementations described below are exemplary implementations provided to enable persons skilled in the art to make or use the embodiments of the disclosure and are not intended to limit the scope of the disclosure, which is defined by the claims. For purposes of description herein, the terms “upper, lower, left, rear, right, front, vertical, and horizontal,” and derivatives thereof shall relate to the invention as oriented in the figures.

Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

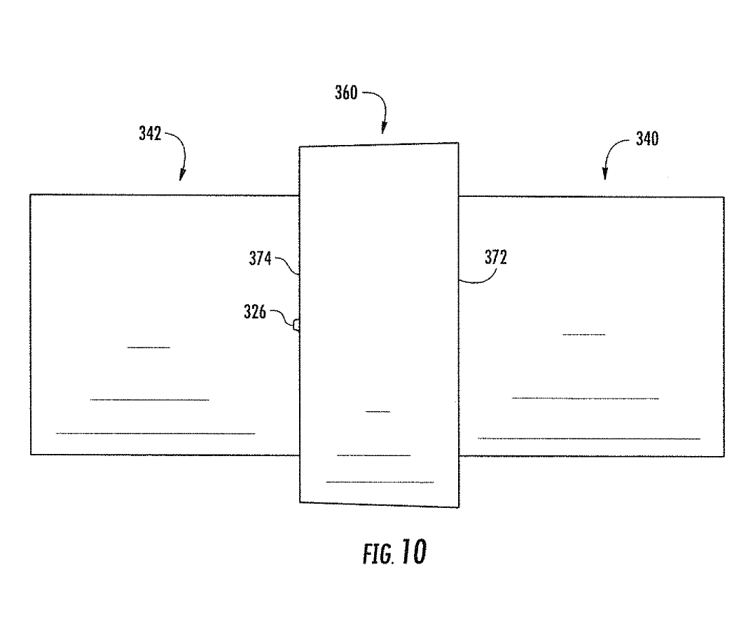

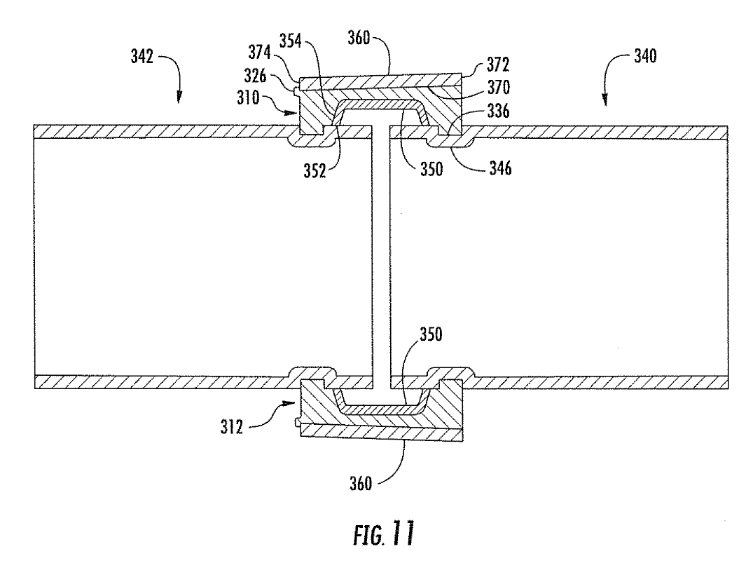

A pipe coupling assembly 300 with sleeve locking tabs will now be discussed in reference to FIGS. 9-13. The pipe coupling assembly 300 is also referred to as a wedge style coupling assembly. Like features of the wedge style coupling assembly 300 and the prior art wedge style coupling assembly 200 are numbered the same except preceded by the numeral “3”.

The pipe coupling assembly includes a first casing member 310 having a first end 322 comprising a first semi-circular shaped, continuous, exterior surface edge defined by a first radius, and a second end 324 comprising a second semi-circular shaped, continuous, exterior surface edge defined by a second radius, with the first radius being smaller than the second radius so that a tapering, continuous, exterior surface 320 extends therebetween. A first sleeve locking tab 326 extends longitudinally and radially outwards from the second semi-circular shaped, continuous, exterior surface edge 324.

A second casing member 312 has a first end comprising a first semi-circular shaped, continuous, exterior surface edge 322 defined by the first radius, and a second end comprising a second semi-circular shaped, continuous, exterior surface edge 324 defined by the second radius, with the first radius being smaller than the second radius so that a tapering, continuous, exterior surface 320 extends therebetween. A second sleeve locking tab 326 extends longitudinally and radially outwards from the second semi-circular shaped, continuous, exterior surface edge 324.

A gasket 350 is to be positioned adjacent first and second pipe sections 340 and 342, and within the first and second casing members 310 and 312. The gasket 350 includes a tapered gasket sidewall 354, wherein the tapered gasket sidewall 354 expands outward as the sidewall extends inward. The interior shape of the gasket receiving feature 330 includes tapered sidewalls, adhering to the contour of the gasket 350.

The gasket 350 is fabricated of a resilient and fluid impervious material and may be molded of natural rubber, a synthetic rubber, a nylon, a compressible composite material, a moldable sealing putty, and the like. Alternately, the gasket 350 may be fabricated of any reasonable material including, ethylene propylene diene monomer (EPDM) (generally used where the transported fluid is water), a nitrile compound (generally used where the transported fluid is oil), fluoro-elastomer, neoprene, white nitrile and epichlorohydrin. A commonly known gasket 350 can be integrated into the design to reduce material sourcing costs and increase overall availability and compatibility. The gasket 350 is commonly provided having a “C” or “U” configured cross-sectional shape.

A sleeve 360 has a first circular end with a first circular interior surface edge 372, a second circular end with a second circular interior surface edge 374, and a tapering interior surface 370 extending therebetween. The tapering interior surface 370 is to be positioned over the tapering exterior surfaces 320 of the first and second casing members 310 and 312.

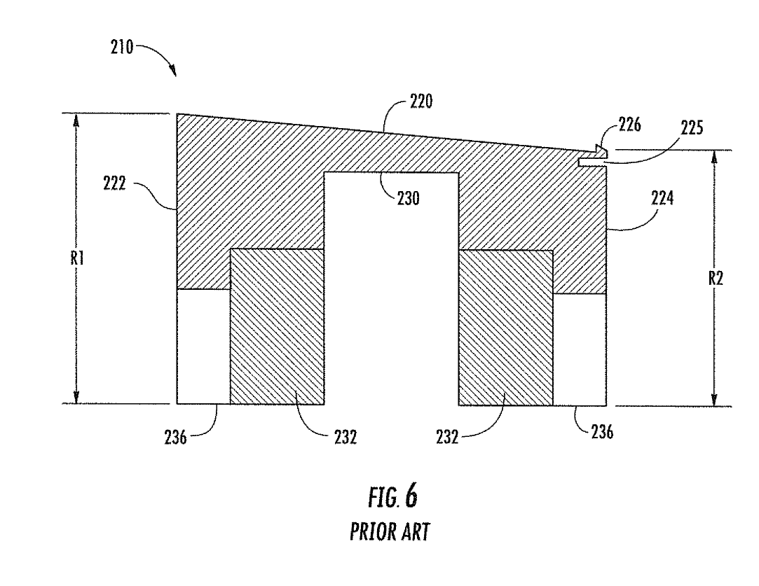

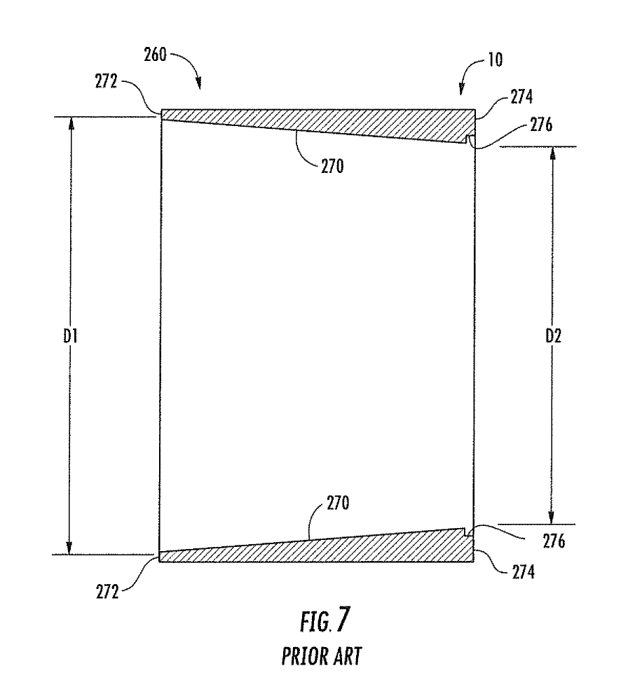

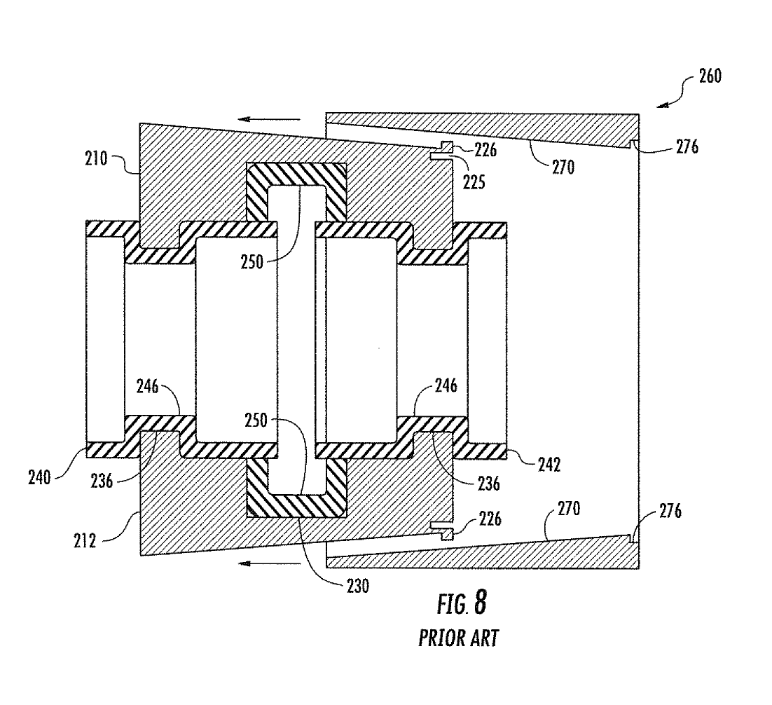

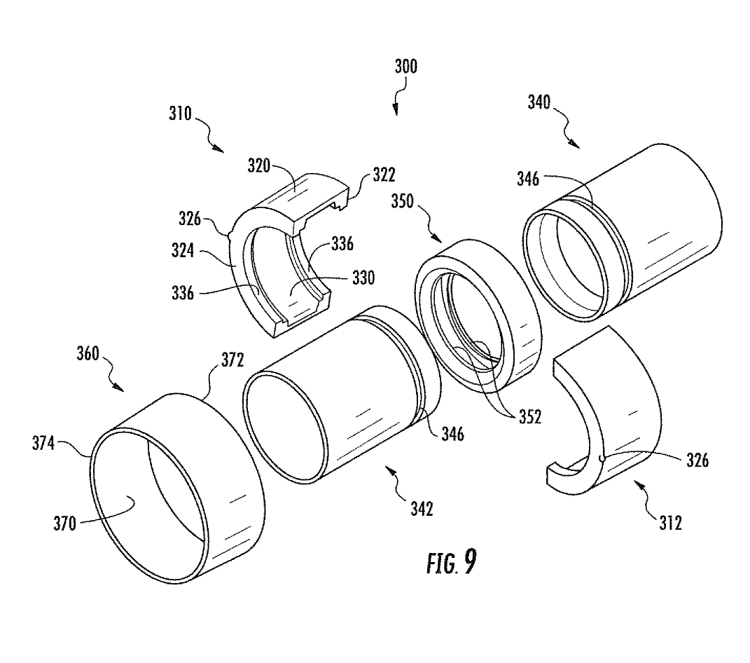

The sleeve 360 is lockable in position surrounding the first and second casing members 310, 312 by engagement with the first and second sleeve locking tabs 326. Since the sleeve locking tabs 326 extend longitudinally and radially outwards from the second semi-circular shaped exterior surface edges 324, a notch or recess is not required to provide a cantilever action as for the sleeve engaging member 226 illustrated in FIGS. 4-7. This allows the exterior surface edges 324 of the second ends of the first and second casing members 310, 312 to be continuous. This allows the gasket 350 to remain properly seated within the first and second casing members 310 and 312, especially when under higher pressures. In addition, vibration of the pipe coupling assembly 300 will not cause the sleeve 360 to slip off the first and second casing members 310, 312.

The first sleeve locking tab 326 is integrally formed with the first casing member 310. Likewise, the second sleeve locking tab 326 is integrally formed with the second casing member. Although the illustrated first and second casing members 310, 312 each have a sleeve locking tab 326 for locking the sleeve 360 in position, other embodiments may include a sleeve locking tab 326 on just one of the casing members or more than one locking tab on each casing member.

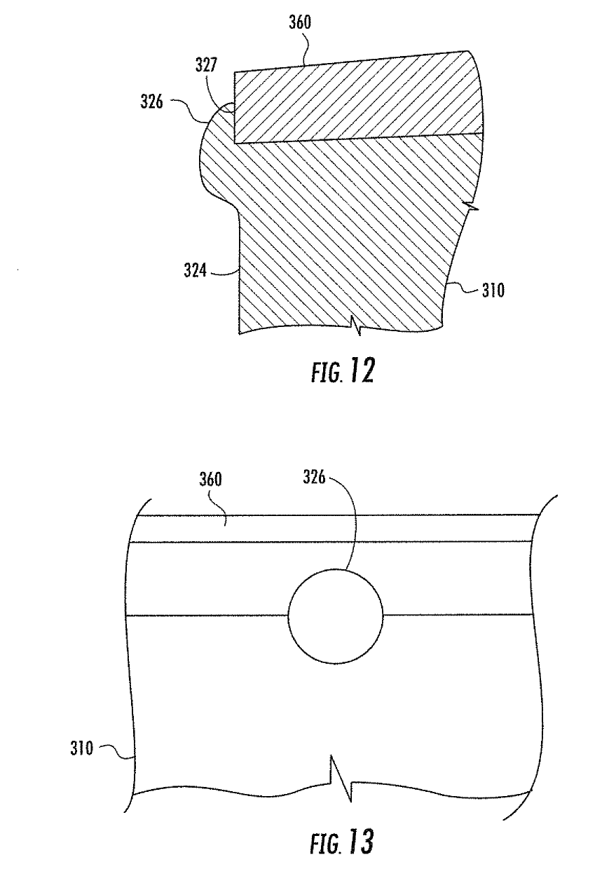

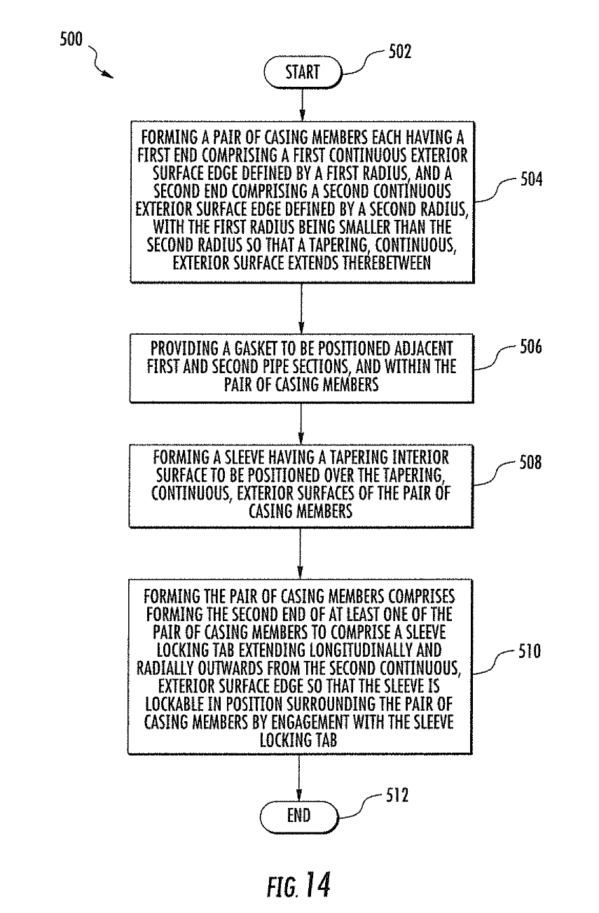

The first and second sleeve locking tabs 326 and the first and second casing members 310, 312 may comprise plastic, for example. As best illustrated in FIGS. 12 and 13, the first and second sleeve locking tabs 326 each extends radially outward from a respective second semi-circular shaped, continuous, exterior surface edge 324 a distance less than a corresponding radial thickness of adjacent portions of the sleeve 360. The first and second sleeve locking tabs 326 also extend radially inward from a respective second semi-circular shaped, continuous, exterior surface edge 324 a same distance. The first and second sleeve locking tabs 326 each extends radially outward from a respective second semi-circular shaped, continuous, exterior surface edge 324 to define a respective sleeve contacting surface 327 being flush with an end face of a respective casing member 310 as perhaps best shown in FIG. 12.

The first and second sleeve locking tabs 326 each comprises rounded over surface portions adjacent respective sleeve contacting surfaces. The first and second sleeve locking tabs 326 are each positioned at a respective midpoint of a respective casing member 310, 312 although other positions are also contemplated.

A flowchart 500 for illustrating a method for making a pipe coupling assembly 300 will now be discussed in reference to FIG. 14. From the start (Block 502), the method comprises forming at Block 504 a pair of casing members 310, 312 each having a first end comprising a first continuous exterior surface edge 322 defined by a first radius, and a second end comprising a second continuous exterior surface edge 324 defined by a second radius. The first radius is smaller than the second radius so that a tapering, continuous, exterior surface 320 extends therebetween.

A gasket 350 is provided at Block 506 to be positioned adjacent first and second pipe sections 340 and 342, and within the pair of casing members 310 and 312. A sleeve 360 is formed at Block 508 having a tapering interior surface 370 to be positioned over the tapering, continuous, exterior surfaces 320 of the pair of casing members 310, 312. The method further comprises forming the pair of casing members at Block 510 to comprise forming the second end 324 of at least one of the pair of casing members 310, 312 to comprise a sleeve locking tab 326 extending longitudinally and radially outwards from the second continuous, exterior surface edge 324 so that the sleeve 360 is lockable in position surrounding the pair of casing members 310, 312 by engagement with the sleeve locking tab 326. The method ends at Block 512.

Another noted advantage of the wedge style pipe coupling assembly 300 is the ability to be disassembled. Referencing the wedge style coupling assembly 300 as an example, the service person would separate the sleeve engaging member 326 from the interior surface edge 374 of the sleeve 360. This can be accomplished using any reasonable tool, a screwdriver, a chisel, and the like. Once disengaged, the service person would apply a separation force to the larger diameter end 372 of the pressure application sleeve 360 to reverse the fitting process.

Once properly assembled, the only protrusions from the completed coupling are the rounded sleeve locking tabs 326. This may be particularly important when the pipe coupling assembly 300 is used on large-scale pipelines, such as large-diameter oil pipelines, where the entire pipeline can move significantly in use, due to expansion and contraction effects caused by temperature differences. Protrusions from prior art pipe couplings, which can become entangled with the ground or other structures, can be torn off or damaged. The lack of any sudden discontinuity from the pipe coupling 300 according to embodiments of the present invention substantially obviates this problem.

Embodiments of the present invention find utility in a range of different pipe environments, ranging from small-bore pipes used in domestic situations up to large diameter pipes used in the transportation of oil, gas or water. Depending on the characteristics of the pipe, the materials used to manufacture the pipe coupling will vary. In some circumstances, the various components of the pipe coupling can be formed from a plastics material, such as glass-filled nylon. In other circumstances, the components can be formed from steel, another metal or an alloy.

The pipe coupling according to the present invention may be a coupling for connecting two lengths of pipe, Alternatively, the pipe coupling according to the present invention may be a coupling for connecting a length of pipe to a pipe joint assembly. Many types of pipe joint assemblies are known, for example, pipe joint assemblies for connecting three lengths of pipe in a T-junction, pipe end caps and pipe joint assemblies incorporating valves or other elements known in the art,

Since many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalence.

That which is claimed is:

1. A pipe coupling assembly comprising:
a first casing member having
a first end comprising a first semi-circular shaped, continuous, exterior surface edge defined by a first radius, and
a second end comprising
a second semi-circular shaped, continuous, exterior surface edge defined by a second radius, with the first radius being smaller than the second radius so that a tapering, continuous, exterior surface extends therebetween, and
a first sleeve locking tab extending longitudinally and radially outwards from the second semi-circular shaped, continuous, exterior surface edge;
a second casing member having
a first end comprising a first semi-circular shaped, continuous, exterior surface edge defined by the first radius, and
a second end comprising
a second semi-circular shaped, continuous, exterior surface edge defined by the second radius, with the first radius being smaller than the second radius so that a tapering, continuous, exterior surface extends therebetween, and
a second sleeve locking tab extending longitudinally and radially outwards from the second semi-circular shaped, continuous, exterior surface edge;
a gasket to be positioned adjacent first and second pipe sections, and within said first and second casing members; and
a sleeve having a first circular end with a first circular interior surface edge, a second circular end with a second circular interior surface edge, and a tapering interior surface extending therebetween, with the tapering interior surface to be positioned over the tapering exterior surfaces of said first and second casing members;
said sleeve being lockable in position surrounding said first and second casing members by engagement with said first and second sleeve locking tabs.

2. The pipe coupling assembly according to claim 1 wherein said first sleeve locking tab is integrally formed with said first casing member; and wherein said second sleeve locking tab is integrally formed with said second casing member.

3. The pipe coupling assembly according to claim 1 wherein said first and second sleeve locking tabs and said first and second casing members comprise plastic.

4. The pipe coupling assembly according to claim 1 wherein said first and second sleeve locking tabs each extends radially outward from a respective second continuous, exterior surface edge a distance less than a corresponding radial thickness of adjacent portions of said sleeve.

5. The pipe coupling assembly according to claim 1 wherein said first and second sleeve locking tabs each extends radially outward and inward from a respective second continuous, exterior surface edge a same distance.

6. The pipe coupling assembly according to claim 1 wherein said first and second sleeve locking tabs each extends radially outward from a respective second continuous, exterior surface edge to define a respective sleeve contacting surface being flush with an end face of a respective casing member.

7. The pipe coupling assembly according to claim 1 wherein said first and second sleeve locking tabs each comprises rounded over surface portions adjacent respective sleeve contacting surfaces.

8. The pipe coupling assembly according to claim 1 wherein said first and second sleeve locking tabs are each positioned at a respective midpoint of a respective casing member.

9. The pipe coupling assembly according to claim 1 wherein said gasket has a U-shaped cross-sectional shape.

10. A pipe coupling assembly comprising:
a pair of casing members each having
a first end comprising a first continuous exterior surface edge defined by a first radius, and
a second end comprising a second continuous exterior surface edge defined by a second radius, with the first radius being smaller than the second radius so that a tapering, continuous, exterior surface extends therebetween, and
a gasket to be positioned adjacent first and second pipe sections, and within said pair of casing members; and
a sleeve having a tapering interior surface to be positioned over the tapering, continuous, exterior surfaces of said pair of casing members;
the second end of at least one of said pair of casing members comprising a sleeve locking tab extending longitudinally and radially outwards from the second continuous, exterior surface edge so that said sleeve is lockable in position surrounding said pair of casing members by engagement with said sleeve locking tab.

11. The pipe coupling assembly according to claim 10 wherein said sleeve locking tab is integrally formed with a respective casing member.

12. The pipe coupling assembly according to claim 10 wherein said second sleeve locking tab and said casing member comprise plastic.

13. The pipe coupling assembly according to claim 10 wherein said sleeve locking tab extends radially outward from a respective second continuous, exterior surface edge a distance less than a corresponding radial thickness of adjacent portions of said sleeve.

14. The pipe coupling assembly according to claim 10 wherein said sleeve locking tab extends radially outward and inward from a respective second continuous, exterior surface edge a same distance.

15. The pipe coupling assembly according to claim 10 wherein said sleeve locking tab extends radially outward from a respective second continuous, exterior surface edge to define a respective sleeve contacting surface being flush with an end face of a respective casing member.

16. The pipe coupling assembly according to claim 10 wherein said sleeve locking tab comprises rounded over surface portions adjacent a respective sleeve contacting surface.

17. The pipe coupling assembly according to claim 10 wherein said sleeve locking tab is positioned at a respective midpoint of a respective casing member.

18. The pipe coupling assembly according to claim 10 wherein the sleeve locking tab on the second end of at least one of said pair of casing members comprises a sleeve locking tab on the second end of each of said pair of casing members.

19. The pipe coupling assembly according to claim 10 wherein said gasket has a U-shaped cross-sectional shape.

20. A method for making a pipe coupling assembly comprising:
forming a pair of casing members each having
a first end comprising a first continuous exterior surface edge defined by a first radius, and
a second end comprising a second continuous exterior surface edge defined by a second radius, with the first radius being smaller than the second radius so that a tapering, continuous, exterior surface extends therebetween, and
providing a gasket to be positioned adjacent first and second pipe sections, and within the pair of casing members; and
forming a sleeve having a tapering interior surface to be positioned over the tapering, continuous, exterior surfaces of the pair of casing members;
wherein forming the pair of casing members comprises forming the second end of at least one of the pair of casing members to comprise a sleeve locking tab extending longitudinally and radially outwards from the second continuous, exterior surface edge so that the sleeve is lockable in position surrounding the pair of casing members by engagement with the sleeve locking tab.

21. The method according to claim 20 wherein the sleeve locking tab is integrally formed with a respective casing member.

22. The method according to claim 20 wherein the sleeve locking tab and a respective casing member comprise plastic.

23. The method according to claim 20 wherein the sleeve locking tab extends radially outward from a respective second continuous, exterior surface edge a distance less than a corresponding radial thickness of adjacent portions of the sleeve.

24. The method according to claim 20 wherein the sleeve locking tab extends radially outward and inward from a respective second continuous, exterior surface edge a same distance.

25. The method according to claim 20 wherein the sleeve locking tab extends radially outward from a respective second continuous, exterior surface edge to define a respective sleeve contacting surface being flush with an end face of a respective casing member.

26. The method according to claim 20 wherein the sleeve locking tab comprises rounded over surface portions adjacent respective sleeve contacting surfaces.

27. The method according to claim 20 wherein the sleeve locking tab is positioned at a respective midpoint of a respective casing member.

28. The method according to claim 20 wherein the sleeve locking tab on the second end of at least one of the pair of casing members comprises a sleeve locking tab on the second end of each of the pair of casing members.

29. The method according to claim 20 wherein the gasket has a U-shaped cross-sectional shape.
